(19) United States
(12) Patent Application Publication
(10) Pub. No.: US 2026/0283169 A1
(43) Pub. Date: Sep. 24, 2026

(54) All-in-One Apparatus of Food Flavoring, Cooking, and Rapid Cooling

(71) Applicant: CULINARY SCIENCES, INC., Campbell, CA (US)

(72) Inventors: George Shu-Xing CHENG, Folsom, CA (US); Gregory P. FATIGATI, Portsmouth, RI (US); Mark LINDER, St. Helena, CA (US); Richard GILLESPIE, San Jose, CA (US); John FIELD, Campbell, CA (US)

(73) Assignee: CULINARY SCIENCES, INC., Campbell, CA (US)

(21) Appl. No.: 19/083,883

(22) Filed: Mar. 19, 2025

(51) Int. Cl. A23B 2/00; A23B 2/10; A23B 2/80; B08B 9/093

(52) U.S. Cl. CPC A23B 2/001; A23B 2/103; A23B 2/805; B08B 9/093

(57) ABSTRACT

A method and apparatus is disclosed relating to food processing facilities and commercial kitchens. The inventive all-in-one apparatus of food flavoring, cooking, and rapid cooling can marinate food in vacuum conditions to save time, cook food with convection heat and steam, and cool food rapidly with extreme vacuum cooling (EVC), all automatically with no human interaction. From loading the raw food into the food chamber of the all-in-one apparatus to taking the flavored, cooked, and chilled food out, this apparatus enables very efficient use of time, energy, space, and manpower. Chamber and food temperatures are controlled, monitored, and recorded during the entire food flavoring, cooking, and rapid cooling process to ensure the compliance of food safety regulations. This all-in-one apparatus can revolutionize the commercial food preparation industry and have a big impact on our society.

The subject of this patent relates to food processing and preparation for commercial kitchens and food processing plants. More particularly, this patent relates to an all-in-one apparatus of food flavoring, cooking, and rapid cooling that can marinate food in vacuum conditions to save time, cook food with convection heat and steam, and cool food rapidly with extreme vacuum cooling (EVC).

In U.S. Pat. No. 11,638,436, the entirety of which is hereby incorporated by reference, we disclosed a method and apparatus of Extreme Vacuum Cooling (EVC), where an EVC cooler can work at ultra low pressure conditions with adaptive pressure control for processing large amounts of food to meet government food safety regulations, save energy and time, and achieve uniform cooling to retain good food quality. The Extreme Vacuum Cooling (EVC) technology is defined as vacuum cooling at extremely low pressure conditions with vacuum chamber pressure control and added clean dry air or inert gas.

In U.S. Pat. No. 12,161,141, the entirety of which is hereby incorporated by reference, we described an extreme vacuum cooling (EVC) technology and apparatus for food flavor infusion. The EVC apparatus can work in ultra low pressure conditions to achieve much more time and energy efficient cooling and flavor infusion. Adaptive pressure control for the food chamber is implemented to prevent liquid splash so that the EVC apparatus can be used effectively for food rapid cooling and flavor infusion with substantial amount of time savings. Using the EVC food flavor infusion apparatus, large amounts of meats, vegetables, and fruits can be marinated or brined with various flavor infusion recipes.

In U.S. patent application Ser. No. 18/079,689, the entirety of which is hereby incorporated by reference, we described a method and apparatus relating to a smart and scalable extreme vacuum cooling (EVC) apparatus based on a scalable and modular design that allows one or multiple food chamber modules to connect to one utility module so that all food chambers can share the available vacuum cooling capacity dynamically.

In U.S. Pat. No. 12,053,006, the entirety of which is hereby incorporated by reference, we described an extreme vacuum cooling (EVC) technology and apparatus that can work in ultra low pressure conditions with adaptive pressure control to prevent potential liquid splash inside the vacuum chamber caused by un-controlled low pressure conditions. Clean air is added into the vacuum chamber to allow the chamber pressure to track a setpoint trajectory that may have ramp up periods in order to prevent liquid splash events. The apparatus enables the user to cool various kinds of foods quickly, save energy, and meet food safety regulations.

In this patent, we describe an all-in-one apparatus of food flavoring, cooking, and rapid cooling. The apparatus can marinate food in vacuum conditions to save time, cook food with convection heat and steam, and cool food rapidly with extreme vacuum cooling (EVC), all automatically with no human interaction. From loading the raw food into the food chamber of the all-in-one apparatus to taking the flavored, cooked, and chilled food out, this apparatus enables very efficient use of time, energy, space, and manpower. Chamber and food temperatures are controlled, monitored, and recorded during the entire food flavoring, cooking, and rapid cooling process to ensure compliance of food safety regulations.

In the accompanying drawing:

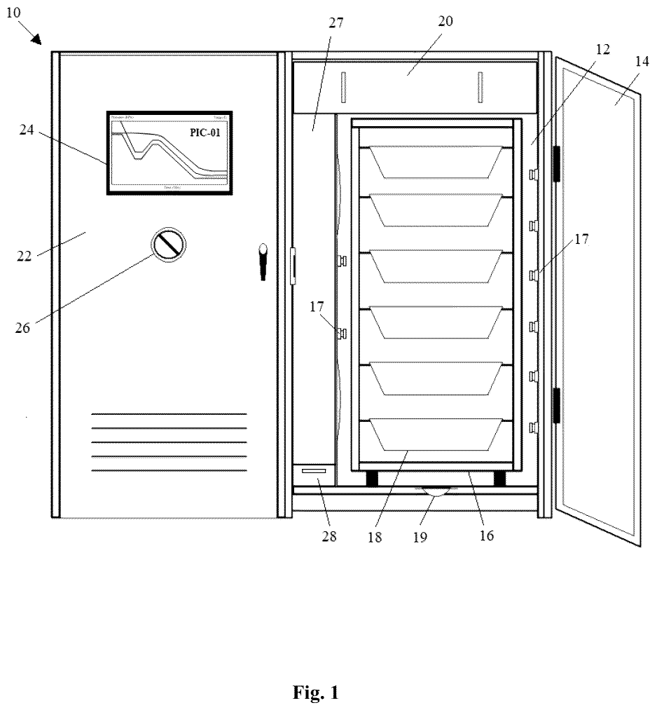

FIG. 1 is a perspective view of an all-in-one apparatus of food flavoring, cooking, and rapid cooling with a single unit design, according to an embodiment of this invention.

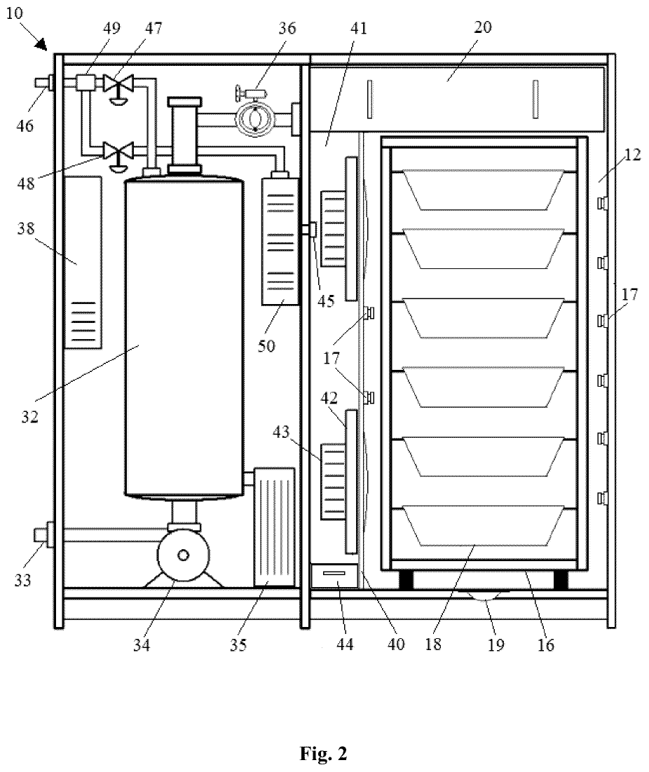

FIG. 2 is a perspective view of an all-in-one apparatus of food flavoring, cooking, and rapid cooling with a single unit design showing more components, according to an embodiment of this invention.

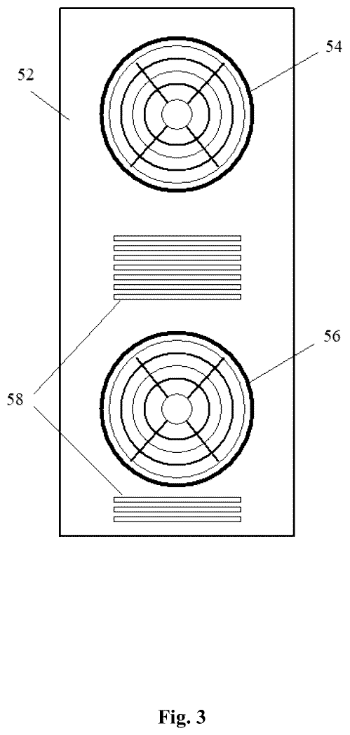

FIG. 3 is a perspective view of a baffle of the all-in-one apparatus showing convection fan grills and baffle slots, according to an embodiment of this invention.

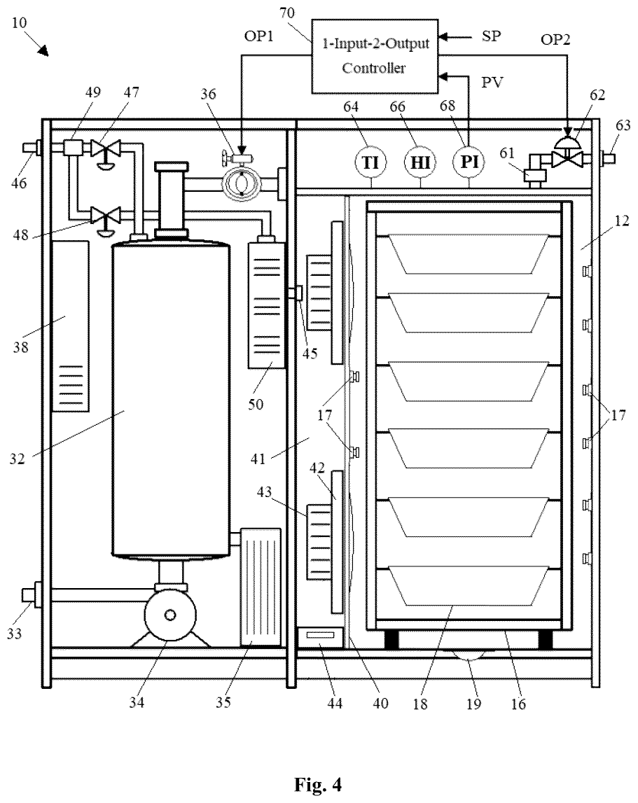

FIG. 4 is a perspective view of an all-in-one apparatus of food flavoring, cooking, and rapid cooling with a single unit design showing all major components with a chamber pressure control system, according to an embodiment of this invention.

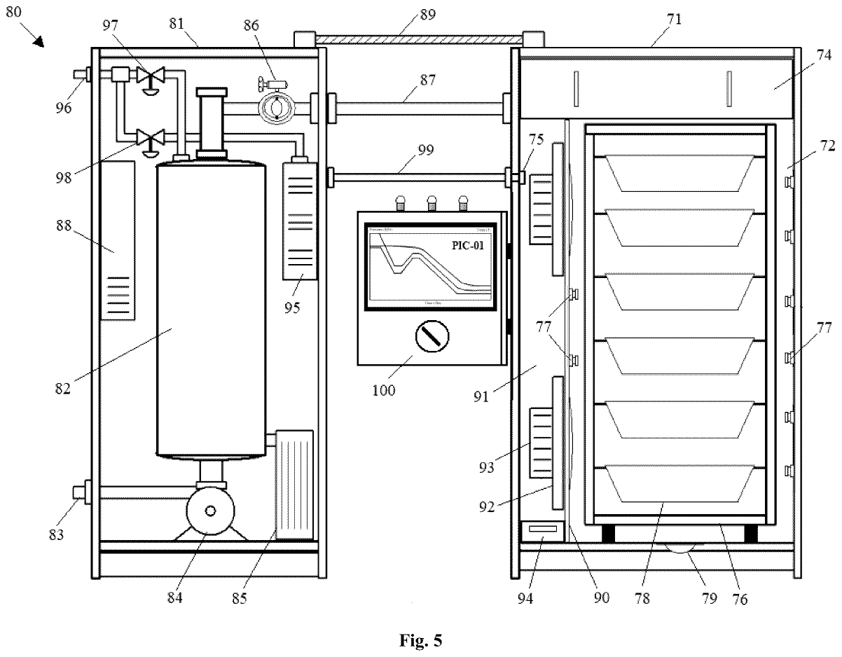

FIG. 5 is a perspective view of an all-in-one apparatus of food flavoring, cooking, and rapid cooling with a dual module design including a food chamber module and a utility module, according to an embodiment of this invention.

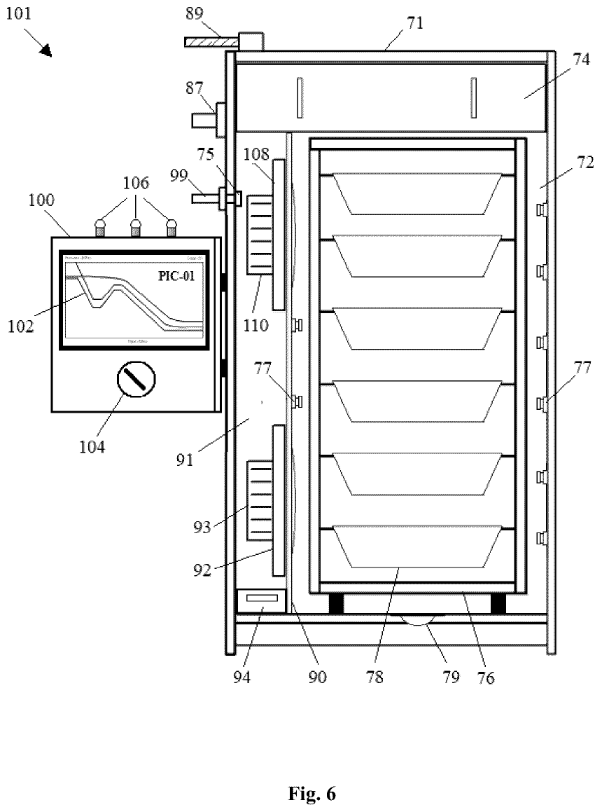

FIG. 6 is a perspective front view of a food chamber module with key components for the all-in-one apparatus of food flavoring, cooking, and rapid cooling, according to an embodiment of this invention.

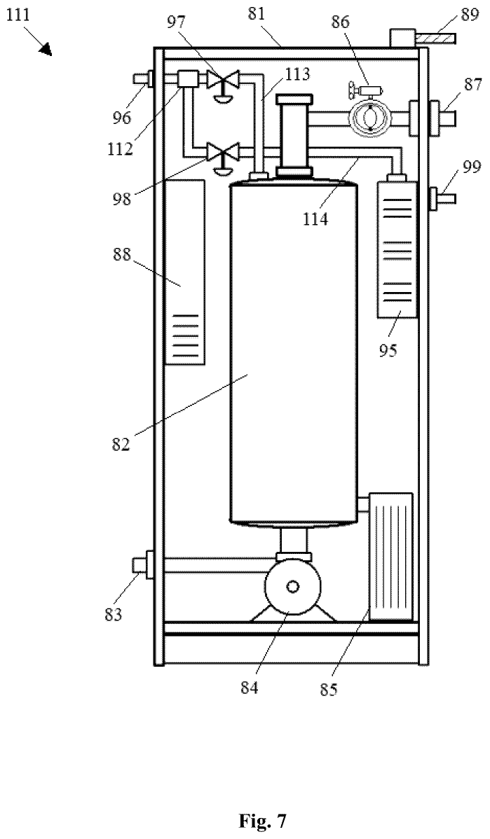

FIG. 7 is a perspective view of a utility module with key components for the all-in-one apparatus of food flavoring, cooking, and rapid cooling, according to an embodiment of this invention.

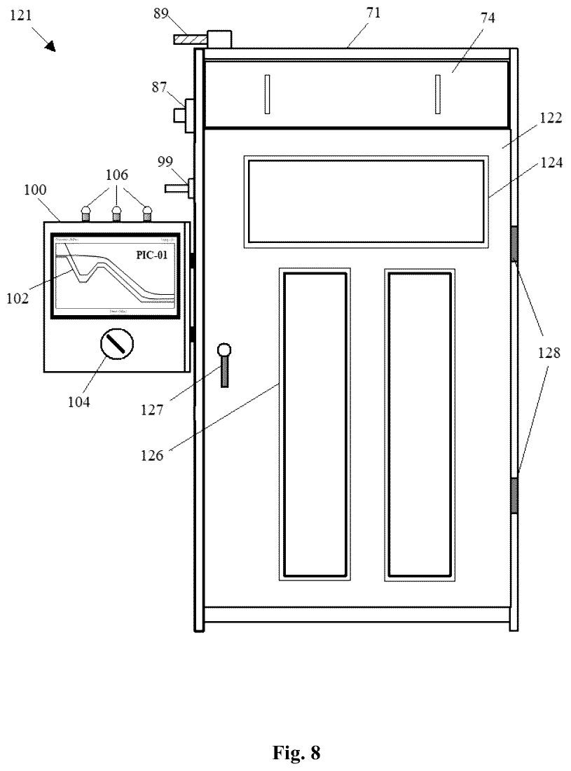

FIG. 8 is a perspective front view of a food chamber module showing a door and windows for the all-in-one apparatus of food flavoring, cooking, and rapid cooling, according to an embodiment of this invention.

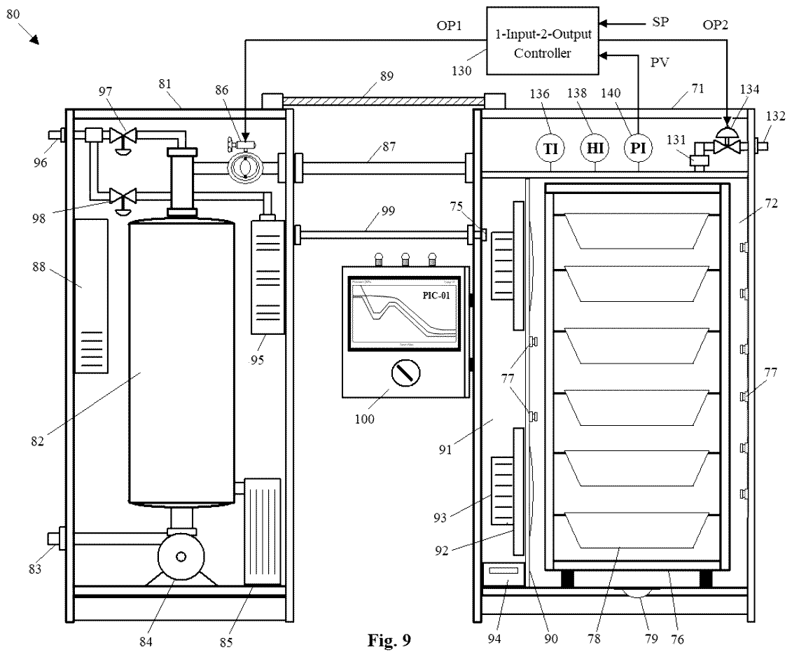

FIG. 9 is a perspective view of an all-in-one apparatus of food flavoring, cooking, and rapid cooling with a dual module design showing all major components with a chamber pressure control system, according to an embodiment of this invention.

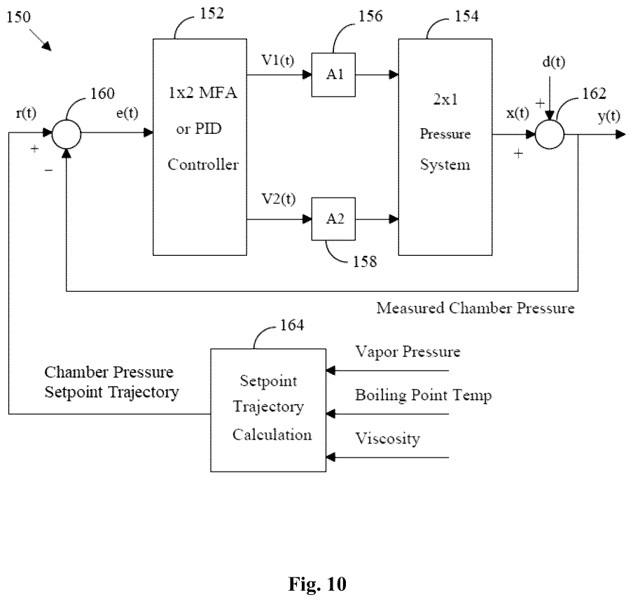

FIG. 10 is a diagram of a 2-Input-1-Output (2×1) pressure control system to control the chamber pressure of the all-in-one apparatus of food flavoring, cooking, and rapid cooling, according to an embodiment of this invention.

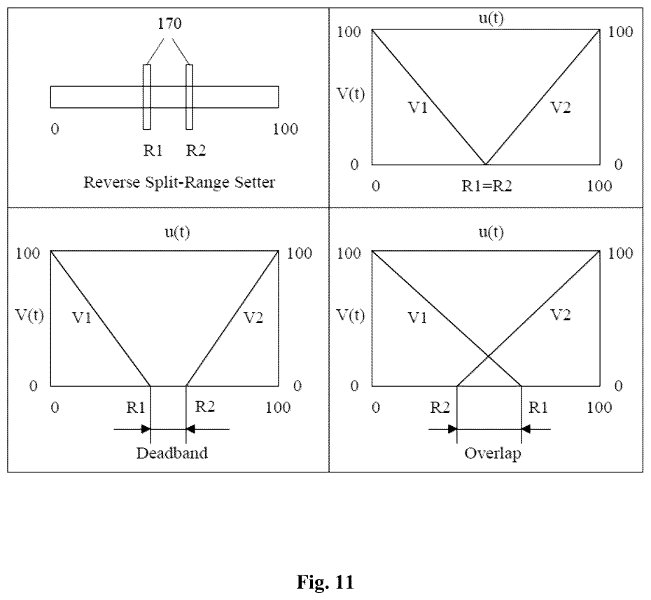

FIG. 11 is a drawing illustrating a mechanism of a reverse split-range setter that can split the controller signal into 2 ranges to manipulate the vacuum control valve and inflow air control valve, according to an embodiment of this invention.

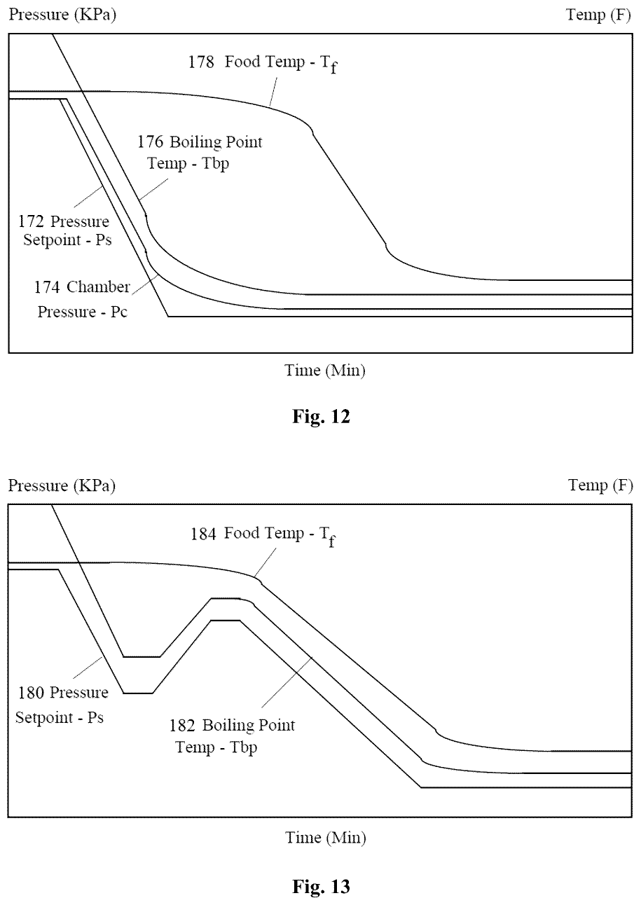

FIG. 12 is a time-amplitude diagram that shows a chamber pressure setpoint trajectory for cooling high viscosity foods, controlled chamber pressure, boiling point temperature, and food temperature, according to an embodiment of this invention.

FIG. 13 is a time-amplitude diagram that shows a chamber pressure setpoint trajectory for food flavoring and for cooling low viscosity foods, as well as boiling point temperature and food temperature, according to an embodiment of this invention.

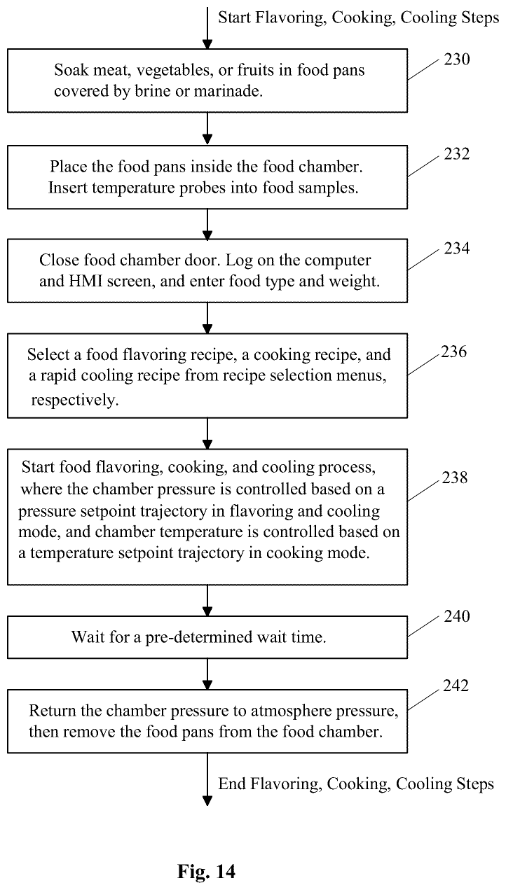

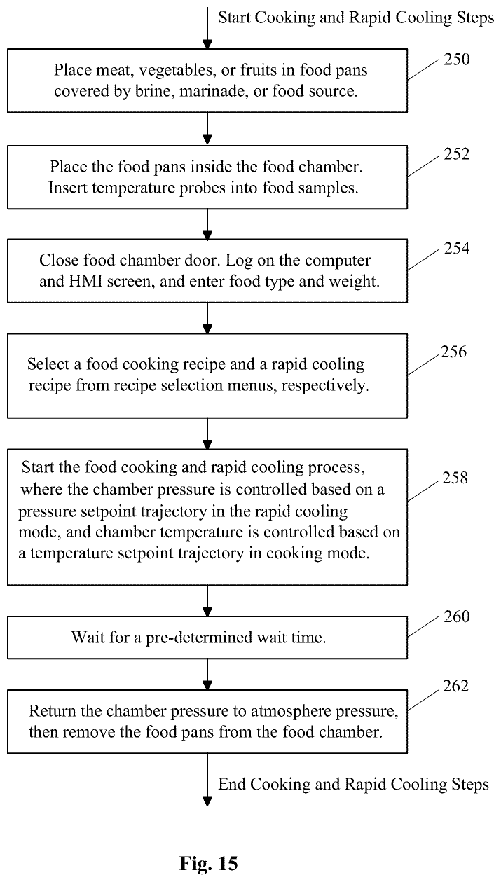

FIG. 14 is a block diagram illustrating the steps of a method for food flavoring, cooking, and rapid cooling using the all-in-one apparatus of food flavoring, cooking, and rapid cooling, according to an embodiment of this invention.

FIG. 15 is a block diagram illustrating the steps of a method for food cooking and rapid cooling using the all-in-one apparatus of food flavoring, cooking, and rapid cooling, according to an embodiment of this invention.

The term mechanism is used herein to represent hardware, software, or any combination thereof. The term EVC refers to Extreme Vacuum Cooling defined and described In U.S. Pat. No. 11,638,436. The term all-in-one apparatus refers to the apparatus that can perform food flavoring, cooking, and rapid cooling introduced in this patent. The term HMI refers to Human-Machine-Interface that includes a computer screen to allow a user to interact with a device. The term IPC refers to Industrial Personal Computers. The term PLC refers to Programmable Logic Controllers. The term PAC refers to Programmable Automation Controllers.

In U.S. Pat. No. 11,638,436, we defined solid foods with high viscosity as Type A Foods, and liquid foods with low viscosity as Type B Foods. For example, Type A Foods include beef, pork, chicken, potatoes, baked foods, and sautéed meats and vegetables. Type B Foods include marinade, brine, salt water, wine, juices, oil, soup, stews, sauces, and spaghetti in sauce.

Without losing generality, all numerical values given in this patent are examples. Other values can be used without departing from the spirit or scope of this invention. The description of specific embodiments herein is for demonstration purposes and in no way limits the scope of this disclosure to exclude other not specifically described embodiments of this invention.

### DESCRIPTION

### A. Food Flavoring and Rapid Cooling with Extreme Vacuum Cooling Technology

Vacuum cooling is based on the principle of evaporative cooling, where water will absorb a large amount of heat in order to evaporate from liquid to gas. Water evaporation can happen at any temperature above the freezing point. When the chamber pressure of the EVC apparatus is intentionally reduced, the vapor pressure of the water inside the food can become higher than the chamber pressure, resulting in rapid conversion of water inside the food into vapor. This water evaporation transfers the energy to cool the food uniformly throughout the entire food substance. The conversion of water into vapor can happen quickly so that the resulting energy transfer can cool the food uniformly and rapidly.

However, if the pressure difference between the chamber pressure and vapor pressure of the water inside the food is too high, excessive bubbling can occur due to rapid evaporation. When the bubbles burst at the food surface, the force of the bubble surface tension can cause a splash inside the chamber. This is not an issue for solid foods, like beef and chicken as the food structure will not come apart when vapor moves through the food into the vacuum chamber. For low viscosity foods, such as soups and sauces, this can be a big issue. We call this a liquid splash event for those low viscosity foods.

In U.S. Pat. No. 11,638,436, solid foods with high viscosity were defined as Type A Foods, and liquid foods with low viscosity were defined as Type B Foods. For example, Type A Foods include beef, pork, chicken, potatoes, baked foods, and sautéed meats and vegetables. Type B Foods include soup, stews, sauces, and spaghetti in sauce. There can be gray areas for being actual Type A or B Foods. In any case, viscosity is used in food cooling recipes and chamber pressure setpoint calculations to ensure that the EVC apparatus can cool all type of foods with good and consistent performance.

Liquid splash events can contaminate the food chamber when the interior chamber surfaces and shelving fixtures are coated with food liquids and sauces. It is important to control the chamber pressure carefully for Type B Foods so that the pressure difference between the chamber pressure and vapor pressure is managed properly and automatically to enable rapid cooling and prevent liquid splash events.

In recent years, the culinary industry has been promoting the concept of plant-forward. It is a type of cooking and eating that emphasizes foods from plant sources including fruits and vegetables, whole grains, legumes, nuts and seeds, plant oils, and herbs and spices for the benefit of our health and the sustainability of our planet. Although a small portion of meats can still be incorporated into a plant-forward dish, this new style of plant based dishes need more flavor to attract consumers.

In a commercial kitchen, chefs and workers need to prepare large amounts of food with certain time limitations. To give food more and better flavor, they often marinate and brine the meats and vegetables before cooking. However, marinating or brining foods using conventional methods can take many hours to days. This can become a main bottleneck for the commercial kitchen. Therefore, it is desirable to provide a food flavor infusion apparatus that can enable the chefs to prepare large amounts of food in a much shorter time.

Flavor infusion and rapid cooling using extreme vacuum cooling (EVC) technologies have been described in U.S. Pat. Nos. 11,638,436, 12,161,141, 12,053,006, and U.S. patent application Ser. No. 18/079,689, In this patent, we disclose an all-in-one apparatus of food flavoring, cooking, and rapid cooling that can marinate food in vacuum conditions to save time, cook food with convection heat and steam, and cool food rapidly with extreme vacuum cooling (EVC), all automatically with no human interaction.

### B. All-In-One Apparatus of Food Flavoring, Cooking, and Rapid Cooling

FIG. 1 is a perspective view of an all-in-one apparatus of food flavoring, cooking, and rapid cooling with a single unit design, according to an embodiment of this invention.

The all-in-one apparatus of food flavoring, cooking, and rapid cooling 10 comprises a food chamber 12, a chamber door 14, a trolley being rolled inside the food chamber 16, food pans on the trolley 18, cleaning jets 17, a drain 19, an instrument panel 20, a cooking compartment panel 27, a cleaning tablet or detergent drawer 28, a left front panel 22, a control and monitoring computer with HMI screen 24, and a system power switch 26.

The food chamber 12 is built so that it can work in extremely low pressure conditions. In this embodiment, the extremely low pressure conditions can be defined as being less than or equal to about 0.1 ATM or 10 kPa. The chamber door 14 allows easy access to the food chamber and can seal the food chamber from the atmosphere pressure. Since the apparatus can operate at extremely low pressure conditions, the food chamber and the chamber door are specially designed and built to deal with the pressure difference of the atmosphere pressure and 0 Pascal vacuum pressure, which is about 100 kPa. The food pan trolley 16 is built of stainless steel with multiple racks to hold food pans or trays. The foodstuffs such as meats, vegetables, noodles, and soup are put inside the food pans 18. The instrument panel 20 comprises sensors, an inflow air control valve and an air filter, electrical wires, and signal wires to be described in more detail in FIG. 4. The cooking compartment panel 27 covers the cooking related components including heaters and convection fans to be described in FIG. 2. The cleaning tablet and detergent drawer 28 allows the user to add cleaning tablets or detergent for food chamber cleaning. The cleaning jets 17 can spray high pressure cleaning solution and water. The water supply line connects to a solenoid valve to provide the water for cleaning. The cleaning tablet or detergent is dissolved to become the cleaning solution. Fresh water is used in the rinse cycle. There are a number of cleaning jets located in different places inside the food chamber to ensure the food chamber can be cleaned properly. The wastewater and rinse water is removed through the drain 19.

The left front panel 22 covers the other main components of the apparatus to be described in FIG. 2. The control and monitoring computer with HMI screen 24 is mounted on the left front panel and can provide chamber pressure control and logic control for the all-in-one apparatus. The human-machine-interface (HMI) screen allows the user to operate the apparatus. The system power switch 26 can turn the apparatus on and off.

In this embodiment, the all-in-one apparatus has a single unit design with all the components assembled as one piece of equipment. It is a simpler design suitable for food flavoring, cooking, and rapid cooling applications where the total payload is relatively small.

FIG. 2 is a perspective view of an all-in-one apparatus of food flavoring, cooking, and rapid cooling with a single unit design showing more components, according to an embodiment of this invention.

The all-in-one apparatus of food flavoring, cooking, and rapid cooling 10 comprises a food chamber 12, a trolley being rolled inside the food chamber 16, food pans on the trolley 18, an instrument panel 20, cleaning jets 17, a drain 19, a cold trap 32, a vacuum pump 34, a vacuum control valve 36, an outflow air outlet 33, a refrigeration unit 35, an electrical panel 38, a water inlet 46, a first water control valve 47, a second water control valve 48, and a steam generator 50. The all-in-one apparatus also comprises a cooking compartment 41, a baffle 40, heaters 42, convection fans 43, a cleaning tablet or detergent drawer 44, and a steam generator outlet 45.

In FIG. 2, the components 12, 16, 17, 18, 19 and 20 have been described in FIG. 1. The cold trap 32 is used to condense water vapor from the food chamber back to liquid form. The vacuum pump 34 can pump air out of the food chamber to reach extremely low pressure conditions. The vacuum control valve 36 is used to isolate the cold trap 32 from the food chamber 12. This valve can also regulate the outflow air when the vacuum pump 34 is running to pump the air out of the food chamber. Therefore, it is used as one of the actuators to control the chamber pressure. The refrigeration unit 35 is used to cool down the cold trap 32 to condense water vapor. The outflow air outlet 33 allows the air to be pumped out to the atmosphere. The electrical panel 38 is used to receive electric power and supply the power to the all-in-one apparatus. The water inlet 46 is connected to the water supply of the installed location. The fresh water enters the cold trap 32 during its cleaning cycle through the junction connector 49 and control valve 47. The fresh water enters the steam generator 50 through the junction connector 49 and control valve 48.

Heaters in a commercial kitchen oven play a major role in generating heat necessary for cooking. They are responsible for providing the heat to reach the required temperature inside the food chamber and ensuring that the food is cooked properly. In the all-in-one apparatus, heaters 42 can be built with electrical coil heating elements. Thermostats and temperature controllers can be used to regulate the output of heaters to maintain the desired cooking temperature inside the food chamber.

Convection fans are used to circulate hot air inside the food chamber for even heat distribution, more efficient and faster cooking, improving browning and crisping, reducing cooking temperature, and multiple rack cooking. As shown in FIG. 2, there are 2 convection fans 43, one fan at the top and another at the bottom of the food chamber. They can be set up to create a vertical air circulation pattern, which facilitates the cooking of multiple food racks simultaneously.

The top fan blows hot air downward, while the bottom fan blows hot air upward. This vertical air circulation pattern helps even heat distribution from the top to the bottom of the chamber. The dual-fan system creates a consistent flow of hot air throughout the oven, ensuring that heat is evenly distributed across all racks. It minimizes temperature variations and prevents hot and cold spots. With even heat distribution, food on all racks can brown and crisp evenly, resulting in uniform texture and appearance.

A steam generator 50 in the all-in-one apparatus can provide heat and introduce moisture into the food chamber. It serves several important functions, including humidity control, crust formation, steaming foods, and combination cooking with dry heat and steam. The all-in-one apparatus can be designed with both steam generation capabilities and electric heating elements or gas burners. The ovens with a dry heat source and steam are known as “combination ovens” or “combi ovens.” They offer the flexibility to use both dry heat and steam in various cooking processes, making them versatile tools in commercial kitchens. Combination ovens can operate in different modes, including Convection Mode, Steam Mode, Combination Mode, and Reversing Mode, where steam and dry heat are alternated to provide precise control over cooking processes. The ability to use steam and electric or gas heating simultaneously or independently offers versatility in a commercial kitchen, allowing chefs and cooks to perform a wide range of cooking techniques and achieve desired results for various dishes. As shown in FIG. 2, the steam generator 50 can generate and provide steam through the steam generator outlet to the food chamber.

The baffle 40 is arranged to separate the cooking compartment 41 and the food chamber 12. It is designed to control and direct the flow of air within the food chamber during cooking to ensure even and consistent cooking.

FIG. 3 is a perspective view of a baffle of the all-in-one apparatus showing convection fan grills and baffle air slots, according to an embodiment of this invention. The baffle 52 comprises an upper convection fan grill 54, a lower convection fan grill 56, and baffle air slots 58.

In the all-in-one apparatus, baffle 52 is designed to control and direct the flow of air within the food chamber during cooking to ensure even and consistent cooking. The baffle can help distribute heat evenly throughout the food chamber and ensures that all parts of the oven receive the same level of heat. Without a baffle, hot spots and cold spots can develop, leading to unevenly cooked food. By directing the flow of hot air, the baffle can help maintain precise temperature control within the oven to achieve good cooking results.

FIG. 4 is a perspective view of an all-in-one apparatus of food flavoring, cooking, and rapid cooling with a single unit design showing all major components with a chamber pressure control system, according to an embodiment of this invention.

The all-in-one apparatus of food flavoring, cooking, and rapid cooling 10 comprises a food chamber 12, a trolley being rolled inside the food chamber 16, food pans on the trolley 18, cleaning jets 17, a drain 19, a cold trap 32, a vacuum pump 34, a vacuum control valve 36, an outflow air outlet 33, a refrigeration unit 35, an electrical panel 38, a water inlet 46, a first water control valve 47, a second water control valve 48, and a steam generator 50. The all-in-one apparatus 10 also comprises a cooking compartment 41, a baffle 40, heaters 42, convection fans 43, a cleaning tablet or detergent drawer 44, and a steam generator outlet 45. The all-in-one apparatus 10 further comprises an inline air filter 61, an inflow air control valve 62, an inflow air inlet 63, temperature sensors 64, a humidity sensor 66, a pressure sensor 68, and a 1-Input-2-Output controller 70.

In FIG. 4, components 12, 16, 17, 18, 19, 32, 33, 34, 35, 36, 38, 40, 41, 42, 43, 44, 45, 46, 47, 48, 49, and 50 have been described in FIGS. 1 and 2. The temperature sensors 64, humidity sensor 66, and pressure sensor 68 are part of the instrument panel 20 in FIGS. 1 and 2. The actual sensor probes are installed inside the food chamber at different locations. For instance, there can be multiple temperature sensor probes that are inserted into food samples in different food pans to measure the food temperature. In addition, there are temperature sensors installed for measuring the chamber temperature. The humidity sensor probe and pressure sensor probe are typically installed at the top of the food chamber.

In FIG. 4, the 1-Input-2-Output controller 70 can provide adaptive chamber pressure control for the food chamber. In order to prevent liquid splash, it is important to control the chamber pressure based on a pre-determined pressure setpoint trajectory that is derived based on food type, viscosity, chamber pressure, food temperature, and boiling point temperature. For food flavor infusion, the foodstuff is submerged under the marinade or brine, which typically have low viscosity. The chamber pressure setpoint trajectory for brining should be determined based on the viscosity of salt water, and the pressure setpoint trajectory for marinating should be derived based on the viscosity of a specific marinade. The chamber pressure control system is described in more details in FIGS. 10 to 13.

FIG. 5 is a perspective view of an all-in-one apparatus of food flavoring, cooking, and rapid cooling with a dual module design including a food chamber module and a utility module, according to an embodiment of this invention.

The all-in-one apparatus of food flavoring, cooking, and rapid cooling apparatus 80 comprises a food chamber module 71, a food chamber 72, an instrument panel 74, a trolley being rolled inside the food chamber 76, food pans on the trolley 78, cleaning jets 77, a drain 79, a cooking compartment 91, a baffle 90, heaters 92, convection fans 93, a cleaning tablet or detergent drawer 94, a steam generator outlet 75, a utility module 81, a cold trap 82, a vacuum pump 84, a vacuum control valve 86, an outflow air outlet 83, a refrigeration unit 85, an electrical panel 88, a water inlet 96, a first water control valve 97, a second water control valve 98, a steam generator 95, a vacuum air connection tube with connectors 87, an electrical and signal wire conduit 89, a steam tube with connectors 99, and a control and monitoring module 100.

Compared with the single unit design of the all-in-one apparatus in FIGS. 1 to 3, this is a dual-module design that separates the food chamber and the utility module. It is suitable for food flavor infusion, cooking, and rapid cooling applications where the total payload is relatively large. The benefits of the dual-module design are many. For instance, the food chamber and the utility module can be built with limited size and weight for easier transportation and installation.

In FIG. 5, the food chamber module 71 is built so that it can work in extremely low pressure conditions. In this embodiment, the extremely low pressure conditions can be defined as being less than or equal to about 0.1 ATM or 10 kPa. Since the apparatus can operate at extremely low pressure conditions, the food chamber and its door are specially designed and built to deal with the pressure difference of the atmosphere pressure and 0 Pascal vacuum pressure, which is about 100 kPa. The food pan trolley 76 is built of stainless steel with multiple racks to hold food pans or trays. The foodstuffs such as meats, vegetables, noodles, and soup are put inside the food pans 78. The instrument panel 74 comprises sensors, an inflow air control valve, electrical wires, and signal wires to be described in more details in FIG. 9.

Inside the utility module 81, the cold trap 82 is used to condense water vapor from the food chamber back to liquid form. The vacuum pump 84 can pump air out of the food chamber to reach extremely low pressure conditions. The vacuum control valve 86 is used to isolate the cold trap 82 from the food chamber 72. In addition, the valve can regulate the outflow air when the vacuum pump 84 is running to pump the air out of the food chamber. Therefore, it is used as one of the actuators to control the chamber pressure. The refrigeration unit 85 is used to cool down the cold trap 82 to condense water vapor. The outflow air outlet 83 allows the air to be pumped out to the atmosphere. The vacuum air tube and connectors 87 can connect the food chamber and the cold trap so that air can be pumped out from the food chamber through the cold trap. The electrical and signal wire conduit 89 houses the electrical wires and signal wires between the food chamber and the utility module. The steam tube with connectors 99 can connect the steam generator 95 and the cooking compartment 91. The control and monitoring module 100 can be attached to the food chamber cabinet.

The baffle 90 is arranged to separate the cooking compartment 91 and the food chamber 72. It is designed to control and direct the flow of air within the food chamber during cooking to ensure even heat distribution.

In this all-in-one apparatus with dual-module design, heaters 92 can be built with electrical coil heating elements. Thermostats and temperature controllers can be used to regulate the output of heaters to maintain the desired cooking temperature inside the food chamber. Convection fans are used to circulate hot air inside the food chamber for even heat distribution, more efficient and faster cooking, improving browning and crisping, reducing cooking temperature, and multiple rack cooking. As shown in FIG. 5, there are 2 convection fans 93, one fan at the top and another at the bottom of the food chamber. They can be set up to create a vertical air circulation pattern, which facilitates the cooking of multiple food racks simultaneously.

The top fan blows hot air downward, while the bottom fan blows hot air upward. This vertical air circulation pattern helps even heat distribution from the top to the bottom of the chamber. The dual-fan system creates a consistent flow of hot air throughout the oven, ensuring that heat is evenly distributed across all racks. It minimizes temperature variations and prevents hot spots and cold spots. The vertical air circulation pattern can also lead to shorter cooking times as the hot air surrounds the food from both the top and bottom, cooking it more quickly. With even heat distribution, food on all racks can brown and crisp evenly, resulting in uniform texture and appearance.

As shown in FIG. 5, the steam generator 95 can generate and provide steam through the steam tube 99 and steam generator outlet 75 to the food chamber 72. Since this all-in-one apparatus with dual-module design has both dry heat and steam, it can function as a combination oven in its cooking mode. It offers the flexibility to use both dry heat and steam in various cooking processes, making them versatile tools in commercial kitchens. Combination ovens can operate in different modes, including Convection Mode, Steam Mode, Combination Mode, and Reversing Mode, where steam and dry heat are alternated to provide precise control over cooking processes. The ability to use steam and electric or gas heating simultaneously or independently offers versatility in a commercial kitchen, allowing chefs and cooks to perform a wide range of cooking techniques and achieve desired results for various dishes.

FIG. 6 is a perspective front view of a food chamber module attached with a control and monitoring module for the all-in-one apparatus of food flavoring, cooking, and rapid cooling, according to an embodiment of this invention.

The food chamber module attached with a control and monitoring module 101 comprises a food chamber module 71, a food chamber 72, an instrument panel 74, a trolley being rolled inside the food chamber 76, food pans on the trolley 78, cleaning jets 77, a drain 79, a cooking compartment 91, a baffle 90, a lower heater 92, an upper heater 108, a lower convection fan 93, and an upper convection fan 110, a cleaning tablet or detergent drawer 94, a steam generator outlet 75, a vacuum air connection tube with connectors 87, an electrical and signal wire conduit 89, a steam tube with connectors 99, a control and monitoring module 100, a control and monitoring computer with HMI screen 102, a system power switch 104, and system status lights 106.

The components 72, 74, 75, 76, 77, 78, 79, 87, 89 and 99 have been described in FIG. 5. Inside the cooking compartment 91, the lower heater 92 and lower convection fan 93 work together as a unit, and the upper heater 108 and upper convection fan 110 work together as a unit in the cooking mode to provide heat and to circulate air for more efficient and even cooking. The baffle 90 can help control and direct the air flow within the food chamber to ensure even and consistent cooking.

The control and monitoring computer with HMI screen 102 can provide chamber pressure control, cooking temperature control, and logic control for the apparatus, and the human-machine-interface (HMI) screen allows the user to operate the apparatus. The control and monitoring computer with HMI screen can be implemented with a few options, including: (a) an industrial personal computer (PC) with Windows or Linux operating system, (b) a programmable logic controller (PLC), (c) a programmable automation controller (PAC), (d) a specially designed control device, or (e) a combination thereof.

The system power switch 104 can turn on or off the power of the apparatus. The system status lights 106 can be designed with three lights. For instance, (a) a solid green light indicates the apparatus is in normal operation when the chamber pressure is at or below the atmosphere pressure; (b) a green light with certain blinking patterns may indicate that the apparatus is in flavoring, or cooking, or cooling mode; (c) an orange light indicates the chamber door is open and the system is not ready to start the vacuum operation; and (d) a red light indicates the system is in error or needs human attention.

For instance, the green light can be designed with the following blinking pattern: (a) solid green indicates the apparatus is in flavor infusion mode, (b) a long blinking green pattern indicates the apparatus is in cooking mode, and (c) a short blinking green pattern indicates the apparatus is in rapid cooling mode.

FIG. 7 is a perspective view of a utility module with key components for the all-in-one apparatus of food flavoring, cooking, and rapid cooling, according to an embodiment of this invention.

The utility module 111 comprises a cold trap 82, a vacuum pump 84, an outflow air outlet 83, a vacuum control valve 86, a refrigeration unit 85, an electrical panel 88, a water inlet 96, a first water control valve 97, a second water control valve 98, a steam generator 95, a vacuum air connection tube and connectors 87, an electrical and signal wire conduit 89, a steam tube with connectors 99, a water junction connector 112, and water pipes 113 and 114.

In FIG. 7, the components 82, 84, 85, 86, 87, 89 and 99 have been described in FIG. 5. The outflow air outlet 83 is connected to the vacuum pump 84 and allows the air to go out to the atmosphere. The water inlet 96 is connected to the water supply of the installed location. The fresh water enters the cold trap 82 during its cleaning cycle through the junction connector 112, control valve 97, and water pipe 113. The fresh water enters the steam generator 95 through the junction connector 112, control valve 98, and water pipe 114.

The electrical panel 88 can receive electric power and supply the power to run the apparatus. Since the apparatus is for the global market, different electric standards throughout the world can be supported. Therefore, the apparatus can be designed to take either 3-phase AC power or single-phase AC power from the local electric grid.

FIG. 8 is a perspective front view of a food chamber module attached with a control and monitoring module showing a door and windows for the all-in-one apparatus of food flavoring, cooking, and rapid cooling, according to an embodiment of this invention.

The food chamber module attached with a control and monitoring module 121 comprises a food chamber module 71, an instrument panel 74, a food chamber door 122, an upper door window 124, lower door windows 126, a door handle and swivel 127, door hinges 128, a vacuum air connection tube with connectors 87, an electrical and signal wire conduit 89, a steam tube with connectors 99, a control and monitoring module 100, a control and monitoring computer with HMI screen 102, a system power switch 104, and system status lights 106.

In FIG. 8, the components 74, 87, 89, 99, 100, 102, 104, and 106 have been described in FIG. 6. The food chamber module 71 is built to work in extremely low pressure conditions. The chamber door 122 allows easy access to the food chamber and can seal the food chamber from the atmosphere pressure. Since the apparatus can operate at extremely low pressure conditions, the food chamber and its door are specially designed and built to deal with the pressure difference of the atmosphere pressure and 0 Pascal vacuum pressure, which is about 100 kPa. The door handle and swivel 127 allow the user to open and close the door and can also lock the food chamber for safe operation. The door hinges 128 can hold the heavy food chamber door for safe operation.

FIG. 9 is a perspective view of an all-in-one apparatus of food flavoring, cooking, and rapid cooling with a dual module design showing all major components with a chamber pressure control system, according to an embodiment of this invention.

The all-in-one apparatus of food flavoring, cooking, and rapid cooling apparatus 80 comprises a food chamber module 71, a utility module 81, and a control and monitoring module 100. Within these 3 main modules, the apparatus 80 further comprises: a food chamber 72, a trolley being rolled inside the food chamber 76, food pans on the trolley 78, cleaning jets 77, a drain 79, a cooking compartment 91, a baffle 90, heaters 92, convection fans 93, a cleaning tablet or detergent drawer 94, a steam generator outlet 75, a cold trap 82, a vacuum pump 84, a vacuum control valve 86, an outflow air outlet 83, a refrigeration unit 85, an electrical panel 88, a water inlet 96, a first water control valve 97, a second water control valve 98, a steam generator 95, a vacuum air connection tube with connectors 87, an electrical and signal wire conduit 89, a steam tube with connectors 99, an inflow air control valve 134, an inline air filter 131, an inflow air inlet 132, temperature sensors 136, a humidity sensor 138, a pressure sensor 140, and a 1-Input-2-Output controller 130.

In FIG. 9, the vacuum control valve 86 is used to isolate the cold trap 82 from the food chamber 72, and can regulate the outflow air when the vacuum pump 84 is running to pump the air out of the food chamber. Therefore, it is used as one of the actuators to control the chamber pressure. The inflow air control valve 134 can regulate the inflow air flow so that it is used as the other actuator for chamber pressure control. The inflow air control valve 134 can also be used as a vent valve. When it is fully opened, air can enter the food chamber freely so that the chamber pressure can return to atmosphere pressure. This is an important step before opening the chamber door to retrieve the rolling trolley and food pans. The inline air filter 131 is used to filter the inflow air so that it is clean for the food chamber. The inflow air inlet 132 allows the air to enter the food chamber through the inflow air control valve 134.

In FIG. 9, the temperature sensors, humidity sensor, and pressure sensor are part of the instrument panel 74 in FIG. 5. The actual sensor probes are installed inside the food chamber at different locations. For instance, there can be multiple temperature sensor probes that are inserted into food samples in different food pans to measure the food temperature. In addition, there are temperature sensors installed for measuring the chamber temperature. The humidity sensor probe and pressure sensor probe are typically installed at the top of the food chamber.

In FIG. 9, the 1-Input-2-Output controller 130 can provide adaptive pressure control for the food chamber. In order to prevent liquid splash, it is important to control the chamber pressure based on a pre-determined pressure setpoint trajectory that is derived based on food type, viscosity, chamber pressure, food temperature, and boiling point temperature. For food flavor infusion, the foodstuff is submerged under the marinade or brine, which typically have low viscosity. The chamber pressure setpoint trajectory for brining should be determined based on the viscosity of salt water, and the pressure setpoint trajectory for marinating should be derived based on the viscosity of a specific marinade. The chamber pressure control system is described in more details in FIGS. 10 and 13.

### C. Adaptive Chamber Pressure Control for the All-in-One Apparatus

FIG. 10 is a diagram of a 2-Input-1-Output (2×1) pressure control system to control the chamber pressure of the all-in-one apparatus of food flavoring, cooking, and rapid cooling, according to an embodiment of this invention.

The 2-Input-1-Output (2×1) pressure control system 150 comprises a 1-input-2-output (1×2) controller 152, a 2-input-1-output (2×1) system 154, actuator A1 156, actuator A2 158, signal adders 160, 162, and a setpoint trajectory calculation mechanism 164. The signals shown in FIG. 10 are as follows:
r(t)—Setpoint.
y(t)—Measured Variable or the Process Variable, y(t)=x(t)+d(t).
x(t)—System Output.
V₁(t)—Controller Output 1 to manipulate Actuator A1.
V₂(t)—Controller Output 2 to manipulate Actuator A2.
d(t)—Disturbance, the disturbance caused by noise or load changes.
e(t)—Error between the Setpoint and Measured Variable, e(t)=r(t)−y(t).

The control objective is for the controller to produce outputs V₁(t) and V₂(t) to manipulate actuators A1 and A2 so that the measured variable y(t) tracks the given trajectory of its setpoint r(t) under variations of setpoint, disturbance, and process dynamics. In other words, the task of the controller is to minimize the error e(t) in real-time.

Automatic control of the chamber pressure of the all-in-one apparatus can be a challenge when using a traditional control method. We have to control the chamber pressure based on a varying pressure setpoint trajectory. In addition, the same pressure control system has to deal with varying food types, payload changes, and other uncertainties. Fundamentally, the 1×2 pressure controller has only 1 input, which is the control error e(t) but has to produce 2 control outputs V₁(t) and V₂(t) to manipulate 2 actuators, the vacuum control valve and the inflow air control valve, simultaneously.

In U.S. Pat. No. 7,142,626, Apparatus and Method of Controlling Multi-Input-Single-Output Systems, a 2-Input-1-Output (2×1) Model-Free Adaptive (MFA) control system is described. The Model-Free Adaptive (MFA) control technology as described in U.S. Pat. Nos. 7,142,626, 6,055,524, and 6,556,980 is an artificial intelligence (AI) technology that uses an artificial neural network (ANN) as a key component of the controller. In U.S. Pat. No. 11,638,436, adaptive chamber pressure control using Model-Free Adaptive (MFA) control technology has been described.

FIG. 11 is a drawing illustrating a mechanism of a reverse split-range setter that can split the controller signal into 2 ranges to manipulate the vacuum control valve and inflow air control valve, according to an embodiment of this invention.

By moving and setting the knobs R₁ and R₂ 170, the controller outputs V₁(t) and V₂(t) are calculated based on the following formulas as implemented in the split-range setter mechanism 170:

$$\begin{matrix}{V}_{1} ( t ) = - 100 \frac{u ( t )}{{R}_{1}} + 100 , & for all u ( t ) ∈ [ 0 , {R}_{1} ] \\ {V}_{1} ( t ) = 0 , & for all u ( t ) ∈ ( {R}_{1} , 100 ]\end{matrix} \qquad \begin{matrix}( 1 a ) \\ ( 1 b )\end{matrix}$$

where 0<R₁≤100, which defines the split range of u(t) for controller output V₁(t); and

$$\begin{matrix}{V}_{2} ( t ) = - 100 \frac{u ( t ) - 100}{{R}_{2} - 100} + 100 , & for all u ( t ) ∈ [ {R}_{2} , 100 ] \\ {V}_{2} ( t ) = 0 , & for all u ( t ) ∈ [ 0 , {R}_{2} )\end{matrix} \qquad \begin{matrix}( 2 a ) \\ ( 2 b )\end{matrix}$$

where 0≤R₂<100, which defines the split range of u(t) for controller output V₂(t). The signals u(t), V₁(t), and V₂(t) all have a working range of 0% to 100%. In this design, the control valves are shut at 0% at their off position. We can move and set the R₁ and R₂ knobs freely within its (0, 100) range to produce controller outputs V₁(t), and V₂(t), where there may be a deadband, or an overlap, or no gaps in between.

For chamber pressure control of the all-in-one apparatus, there are 3 working conditions:
(1) the vacuum control valve is open and inflow air flow valve is closed, chamber pressure is decreasing;
(2) both vacuum control valve and inflow air control valve are closed, chamber pressure is holding steady; and
(3) the vacuum control valve is closed and inflow air flow valve is open, chamber pressure is increasing.

Then, we can move and set the R₁ and R₂ knobs to have an adequate deadband to support all 3 working conditions. For instance, we can set the R₁=40, and R₂=60. When u(t)<40, the vacuum control valve is open to move air out of the chamber causing the chamber pressure to decrease. Inside the deadband, where 40<u(t)<60, V₁(t)=V₂(t)=0 forcing both control valves to be closed. When u(t)>60, the inflow air control valve is open. Clean air flows into the chamber causing the pressure to increase.

U.S. Pat. No. 7,142,626 also described 2×1 PID (Proportional-Integral-Derivative) control systems which could potentially be useful for chamber pressure control for the all-in-one apparatus. When the Derivative action is taken out of a PID controller, it becomes a PI controller. When the Integral action is taken out of a PI controller, it becomes a P controller. Both PI and P controllers could potentially be useful for chamber pressure control, although their performance will not be as good as an MFA controller.

### D. Design of Setpoint Trajectory for Chamber Pressure Control

As defined in the opening section of this specification, Extreme Vacuum Cooling (EVC) is vacuum cooling at extremely low pressure conditions with vacuum chamber pressure control and added clean dry air or inert gas. The all-in-one apparatus disclosed in this patent can be used to marinate or brine meats, vegetables, and fruits. It can also provide rapid cooling for foods with low viscosity.

One major challenge for the all-in-one apparatus is the potential liquid splash problem for rapid cooling of Type B Foods with low viscosity and for food flavor infusion. When the pressure difference between the chamber pressure and vapor pressure of water inside the food is too high, excessive bubbling can occur due to rapid evaporation. For low viscosity foods, such as soups and sauces, and for food flavor infusion with brine and marinade, this liquid splash problem can be a big headache for the users. It is important to control the chamber pressure carefully for Type B Foods and for food flavor infusion so that the pressure difference between the chamber pressure and vapor pressure is managed properly and automatically to enable rapid cooling yet have no liquid splash events.

FIG. 12 is a time-amplitude diagram that shows a chamber pressure setpoint trajectory for cooling high viscosity foods, controlled chamber pressure, boiling point temperature, and food temperature, according to an embodiment of this invention. The diagram comprises trends for the pressure setpoint Ps 172, chamber pressure Pc 174, boiling point temperature Tbp 176, and food temperature Tf 178.

Since liquid splash events do not happen for Type A Foods, we can reduce the vacuum pressure more aggressively based on the capability of the all-in-one apparatus. For instance, the vacuum pressure setpoint Ps 172 can be designed to change from atmosphere pressure (1.0 ATM or 100 KPa) to extremely low pressure (0.01 ATM or about 1.0 KPa) to achieve rapid vacuum cooling. The chamber pressure Pc 174 can be controlled to track its setpoint Ps 172. In this case, the 1×2 pressure controller described in Section C will work in its OP range between 0 to 40 to manipulate the vacuum control valve and achieve pressure control, while the inflow air control valve is closed.

The boiling point of a substance is the temperature at which the vapor pressure of a liquid equals the pressure surrounding the liquid when the liquid changes into a vapor. Therefore, in the vacuum chamber, the boiling point temperature of water inside the food is directly related to the chamber pressure. It can be seen that the boiling point temperature Tbp 176 of the water inside the food changes along with the chamber pressure Pc 174. The food inside the chamber cools down gradually and its temperature is measured by the temperature sensors to produce the Food Temp Tf. Please note that there is a time lag between Tbp 176 and Tf 178. For Type A Foods, this temperature difference is not an issue.

For Type A Foods, the chamber pressure setpoint trajectory can be based on the following formula as illustrated in FIG. 12:

$$\begin{matrix}Ps ( t ) = Pi ( 0 ) - a * t ; & During initial ramp down period ; \\ Ps ( t ) = C ; & During the holding and endpoint period .\end{matrix} \qquad \begin{matrix}( 3 a ) \\ ( 3 b )\end{matrix}$$

In these formulas, Pi(0) is the initial value of the chamber pressure, constant a is the slope of pressure ramp down, and constant C is the pressure setpoint for the all-in-one apparatus to run at a fixed vacuum pressure. The actual values of the slope and constants are related to the capability of the all-in-one apparatus, food viscosity, total weight, and the difference between boiling point temperature and food temperature, etc. They can be derived through experiments and stored in cooling recipes as pre-determined values. Please note, for Type B Foods, if we run the all-in-one apparatus based on the pressure setpoint trajectory showing in FIG. 12, the big temperature difference of Tbp and Tf can cause liquid splash.

FIG. 13 is a time-amplitude diagram that shows a chamber pressure setpoint trajectory for cooling low viscosity foods and for food flavor infusion, as well as boiling point temperature and food temperature, according to an embodiment of this invention.

As explained in Section A of this document, if the pressure difference between the chamber pressure and vapor pressure of water inside the food is too high, excessive bubbling can occur due to rapid evaporation. When the bubbles burst at the food surface, the force of the bubble surface tension can cause liquid splash inside the chamber for Type B Foods. It is important to control the chamber pressure carefully for Type B Foods and for food flavor infusion so that the pressure difference between the chamber pressure and vapor pressure is managed in such a way that the all-in-one apparatus can enable rapid cooling or flavor infusion while preventing liquid splash events.

Since the boiling point temperature has a direct relationship with the chamber pressure, we can also control the chamber pressure with constraints based on the difference between the boiling point temperature and food temperature to prevent liquid splash for Type B Foods. As illustrated in FIG. 13, the chamber pressure setpoint Ps 180 can be reduced at the beginning to give a kick start for vacuum cooling. In this drawing, the measured chamber pressure is not shown but should track the pressure setpoint Ps 180. In this case, we can assume the chamber pressure is equivalent to the pressure setpoint. The boiling point temperature Tbp 182 comes down as the chamber pressure comes down. After that, we can intentionally hold the pressure for a while and then increase the chamber pressure by closing the vacuum control valve and adding clean dry air into the chamber to reach a pressure level and then wait there while the food temperature Tf 184 starts to fall. The goal of adding clean air is to raise the chamber pressure and maintain a temperature difference between Tbp and Tf so that liquid splash will not happen.

As illustrated in FIG. 13, the chamber pressure setpoint trajectory can be calculated based on vapor pressure, boiling point temperature, and viscosity. The formulas to calculate vapor pressure and boiling point temperature relating to viscosity that can be used in this embodiment are any of known techniques described in the book Perry's Chemical Engineers' Handbook, by Don Green and Marylee Z. Southard, published by McGraw-Hill Education, wherein the book and its contents are herein expressly incorporated by reference, in their entirety.

Without losing generality, we can design the chamber pressure setpoint Ps (t) for cooling Type B Foods and for food flavor infusion based on the following formula, which is illustrated in FIG. 13:

$$\begin{matrix}Ps ( t ) = Pi ( 0 ) - a * t ; & During initial ramp down period ; & ( 4 a ) \\ Ps ( t ) = C 1 ; & During the first holding period ; & ( 4 b ) \\ Ps ( t ) = C 1 + b * t ; & During the ramp up period ; & ( 4 c ) \\ Ps ( t ) = C 2 ; & During the second holding period ; & ( 4 d ) \\ Ps ( t ) = C 2 - d * t ; & During the second ramp down ; & ( 4 e ) \\ Ps ( t ) = C 3 , & During the endpoint period . & ( 4 f )\end{matrix}$$

In these formulas, Pi(0) is the initial value of the chamber pressure, constants a, b, and d are the slopes of pressure ramp down, ramp up, and final ramp down. Constants C1, C2, and C3 are the pressure setpoints for the all-in-one apparatus to run at a fixed vacuum pressure. The actual values of the slopes and constants are related to the capability of the all-in-one apparatus, food viscosity, total weight, and the difference between boiling point temperature and food temperature, etc. They can be derived through experiments and stored in cooling or flavor infusion recipes as pre-determined values. When doing the experiments, the food or marinade viscosity can be measured using a viscosity analyzer.

For food flavoring, salt water is usually used for brining. Marinade can include soy sauce, teriyaki sauce, buttermilk, yogurt, tomato sauce, wine, liquor, vinegar, papaya juice, orange juice, kiwi juice, pineapple juice, apple juice, olive oil, salt water, or a combination of these ingredients. Therefore, viscosity for different marinades can vary greatly. The chamber pressure setpoint trajectory for marinating can be derived through certain formulas and experiments and saved in a computer database. The user can retrieve the trajectory as part of the brining or marinating recipe when using the all-in-one apparatus.

### E. Method of Food Flavor Flavoring, Cooking, and Rapid Cooling

FIG. 14 is a block diagram illustrating the steps of a method for food flavoring, cooking, and rapid cooling using the all-in-one apparatus of food flavoring, cooking, and rapid cooling, according to an embodiment of this invention.

The food flavoring, cooking, and rapid cooling steps start at Block 230, where meats, vegetables, or fruits are soaked in food pans covered by marinade or brine. At Block 232, the food pans are placed inside the food chamber of the all-in-one apparatus. In addition, multiple temperature sensor probes are inserted into food samples for food temperature measurement. An average value can be used as food temperature Tf for temperature monitoring and chamber pressure setpoint trajectory calculations as described in Section D.

At Block 234, the operator closes the chamber door, logs onto the control and monitoring computer with HMI screen, and enters food information including food type and total weight. At Block 236, a food flavoring recipe is selected from a flavoring recipe selection menu, a food cooking recipe is selected from a cooking recipe selection menu, and a food rapid cooling recipe is selected from a cooling recipe selection menu.

At Block 238, the operator starts the food flavoring, cooking, and rapid cooling process, where the chamber pressure is controlled based on a pre-determined pressure setpoint trajectory during food flavoring and rapid cooling, and the chamber temperature is controlled based on a pre-determined temperature setpoint trajectory during cooking. The chamber pressure setpoint trajectory calculation is very much related to the Food Type A or B as illustrated in FIGS. 12 and 13.

At Block 240, the operator waits for a pre-determined time for the entire food flavoring, cooking, and rapid cooling process.

At Block 242, the entire food flavoring, cooking, and rapid cooling process is finished and the food chamber pressure is returned to atmosphere pressure. Then the food pans are removed from the food chamber.

FIG. 15 is a block diagram illustrating the steps of a method for food cooking and rapid cooling using the all-in-one apparatus of food flavoring, cooking, and rapid cooling, according to an embodiment of this invention.

The all-in-one apparatus of food flavoring, cooking, and rapid cooling can be conveniently used to perform only one or two of the three steps. For instance, the apparatus can be used for cooking and rapid cooling, but not food flavoring. In FIG. 15, the food cooking and rapid cooling steps start at Block 250, where meats, vegetables, or fruits are placed in food pans covered by food sauce. At Block 252, the food pans are placed inside the food chamber of the all-in-one apparatus. In addition, multiple temperature sensor probes are inserted into food samples for food temperature measurement. An average value can be used as food temperature Tf for temperature monitoring and chamber pressure setpoint trajectory calculations as described in Section D.

At Block 254, the operator closes the chamber door, logs onto the control and monitoring computer with HMI screen, and enters food information including food type and total weight. At Block 256, a food cooking recipe is selected from a cooking recipe selection menu, and a food rapid cooling recipe is selected from a cooling recipe selection menu.

At Block 258, the operator starts the food cooking and rapid cooling process, where the chamber pressure is controlled based on a pre-determined pressure setpoint trajectory during rapid cooling, and the chamber temperature is controlled based on a pre-determined temperature setpoint trajectory during cooking.

At Block 260, the operator waits for a pre-determined time for the entire food cooking and rapid cooling process.

At Block 262, the entire food cooking and rapid cooling process is finished and the food chamber pressure is returned to atmosphere pressure. Then the food pans are removed from the food chamber.

### F. Conclusion

The motivation to develop Extreme Vacuum Cooling (EVC) technology and the disclosed all in one apparatus for food flavoring, cooking, and rapidly cooling products fits the mega trend of the food industry transformation. Similar to a semiconductor foundry, a food foundry is a modern commercial kitchen or food processing plant that can produce large amounts of food with special recipes in small packages to serve dedicated or targeted customer groups. In a food foundry, large amounts of food need to be flavored, cooked, and chilled for future consumption.

Large commercial kitchens and food preparation facilities are constantly looking for ways to become more efficient and to reduce the time it takes to prepare various food products that need to be cooked and then rapidly chilled to refrigeration temperature before further processing.

In a commercial kitchen, vacuum tumblers are used for food flavoring, cooking ovens are used for cooking, and blast chillers are used for cooling. These three pieces of equipment are often not located in close proximity to each other. Moving large amounts of food from one piece of equipment to the next is labor intensive, time consuming, and can also cause food safety issues.

The inventive all-in-one apparatus of food flavoring, cooking, and rapid cooling can marinate food in vacuum conditions to save time, cook food with convection heat and steam, and cool food rapidly with extreme vacuum cooling (EVC), all automatically with no human interaction. From loading the raw food into the food chamber of the all-in-one apparatus to taking the flavored, cooked, and chilled food out, this apparatus enables very efficient use of time, energy, space, and manpower. Chamber and food temperatures are controlled, monitored, and recorded during the entire food flavoring, cooking, and rapid cooling process to ensure compliance of food safety regulations.

In addition, a food processing facility designed based on the all-in-one apparatus can significantly reduce the required equipment space as the vacuum tumblers and blast chillers could be eliminated. The all-in-one apparatus can revolutionize food processing facilities based on the concept of having raw materials in and finished products out with minimal human interaction.

The inventors of this patent have many years of experience in technology innovation to serve or even lead the mega trends in the transformation of industrial automation, renewable energy, and semiconductor equipment. It is our goal to contribute to and support the food industry and our society where people are looking for healthier, more flavorful, and affordable foods.

1. An apparatus that combines functions for food flavoring, cooking, and rapid cooling, the apparatus comprising:
a) a food chamber adapted to work in high temperature conditions in a cooking mode and in low pressure conditions in a cooling mode;
b) a cooking compartment that comprises a heat source for cooking, and one or multiple convection fans adapted to circulate hot air evenly within the food chamber when in the cooking mode;
c) a vacuum pump adapted to pump air out of the food chamber to reach the low pressure conditions;
d) a cold trap arranged to condense water vapor from the food chamber back to liquid form;
e) a vacuum control valve adapted to isolate the cold trap from the food chamber, and to regulate exhaust air flow;
f) an electrical panel adapted to receive electric power and supply the power to the apparatus; and
g) a control and monitoring computer with a Human-Machine-Interface (HMI) screen that enables chamber temperature and pressure control, and allows a user to operate the apparatus.

2. The apparatus of claim 1, wherein the food chamber comprises multiple racks to hold food pans or a rolling trolley that holds multiple food pans.

3. The apparatus of claim 1, wherein the low pressure conditions have a chamber pressure less than or equal to about 0.1 ATM or 10 kPa.

4. The apparatus of claim 1, further comprising an inflow air control valve adapted to regulate added clean air flow and serve as a vent valve to allow the food chamber to return to atmosphere pressure.

5. The apparatus of claim 1, further comprising:
a) an inline air filter adapted to filter inflow air;
b) a refrigeration unit adapted to cool the cold trap;
c) a plurality of temperature sensors whose probes can be inserted into food samples in food pans and being adapted to measure food temperatures;
d) a plurality of temperature sensors adapted to measure food chamber temperatures; and
e) a pressure sensor adapted to measure the pressure of the food chamber.

6. The apparatus of claim 1, wherein the heat source is an electric heater, a gas heater, a steam generator, or a combination thereof.

7. The apparatus of claim 1, further comprising a baffle with convection fan grills and baffle air slots that is adapted to separate the cooking compartment and the food chamber and to direct air flow within the food chamber to ensure even and consistent cooking.

8. The apparatus of claim 6, further comprising a fresh water supply line for the steam generator and for cleaning the food chamber and cold trap.

9. The apparatus of claim 1, further comprising:
a) cleaning jets being located in different places inside the food chamber and adapted to spray high pressure cleaning solution and water to clean the food chamber;
b) a cleaning tablet or detergent drawer allowing the user to add cleaning tablets or detergent for the food chamber cleaning; and
c) a drain arranged to remove wastewater and rinse water.

10. The apparatus of claim 1, further comprising a 2-Input-1-Output (2×1) pressure control system to control the food chamber pressure, the 2×1 pressure control system further comprising:
a) a 1-input-2-output (1×2) pressure controller;
b) a 2-input-1-output (2×1) pressure system;
c) an actuator 1 being the vacuum control valve;
d) an actuator 2 being the inflow air control valve; and
e) a pressure setpoint trajectory calculation mechanism.

11. The control system of claim 10, wherein the 1-input-2-output (1×2) pressure controller is a Model-Free Adaptive (MFA) controller, a Proportional-Integral-Derivative (PID) controller, a Proportional-Integral (PI) controller, or a Proportional controller (P), comprising a split-range setter adapted to produce control output 1 and 2 to manipulate actuator 1 and 2.

12. An apparatus that combines functions for food flavoring, cooking, and rapid cooling, the apparatus comprising:
a) a food chamber module comprising:
(i) a food chamber adapted to work in high temperature conditions in a cooking mode and in low pressure conditions in a cooling mode; and
(ii) a cooking compartment that comprises a heat source for cooking, and one or multiple convection fans adapted to circulate hot air evenly within the food chamber when in the cooking mode;
b) a utility module being connected to the food chamber and comprising:
(i) a vacuum pump adapted to pump air out of the food chamber to reach the low pressure conditions;
(ii) a cold trap adapted to condense water vapor from the food chamber back to liquid form;
(iii) a refrigeration unit adapted to cool the cold trap;
(iv) a vacuum control valve adapted to isolate the cold trap from the food chamber, and to regulate the exhaust air flow; and
(v) an electrical panel adapted to receive electric power and supply the power to the apparatus;
c) a control and monitoring module comprising:
(i) a computer and control device adapted to enable chamber pressure control and chamber temperature control; and
(ii) a Human-Machine-Interface (HMI) screen adapted to allow a user to operate the apparatus.

13. The apparatus of claim 12, further comprising a steam generator inside the utility module.

14. The apparatus of claim 12, further comprising an instrument panel comprising:
a) an inline air filter adapted to filter inflow air;
b) a plurality of temperature sensors whose probes can be inserted into food samples in food pans and being adapted to measure food temperatures;
c) a plurality of temperature sensors adapted to measure the chamber temperature for chamber temperature monitoring and control;
d) a humidity sensor adapted to measure the humidity of the food chamber; and
e) a pressure sensor adapted to measure the pressure of the food chamber.

15. The apparatus of claim 13, further comprising:
(a) a vacuum air connection tube that connects the food chamber and cold trap so air can pass through;
(b) a conduit that houses the electrical and signal wires connecting the food chamber module, utility module, and control and monitoring module, and
c) a steam tube with connectors adapted to connect the steam generator and the cooking compartment.

16. The apparatus of claim 12, wherein the control and monitoring module further comprises:
a) a system power switch adapted to turn the apparatus on or off; and
b) a plurality of system status lights adapted to indicate the food flavoring mode, cooking mode, cooling mode, or abnormal status of the apparatus.

17. The apparatus of claim 12, further comprising a 2-Input-1-Output (2×1) pressure control system to control the food chamber pressure, the 2×1 pressure control system further comprising:
a) 1-input-2-output (1×2) pressure controller;
b) a 2-input-1-output (2×1) pressure system;
c) an actuator 1 being the vacuum control valve; an actuator 2 being the inflow air control valve; and
d) a pressure setpoint trajectory calculation mechanism.

18. A method of food flavoring, cooking, and rapid cooling using an apparatus that combines functions for food flavoring, cooking, and rapid cooling having a food chamber, comprising:
a) Soaking the meats, vegetables, or fruits in food pans covered by marinade or brine;
b) Placing the food pans inside the food chamber;
c) Inserting temperature sensor probes into food samples for measuring the food temperature;
d) Closing the chamber door;
e) Logging onto a computer and a Human-Machine-Interface (HMI) screen, and entering food information including the food type and total weight;
f) Selecting a food flavoring recipe from a recipe selection menu;
g) Selecting a cooking recipe from a recipe selection menu;
h) Selecting a rapid cooling recipe from a recipe selection menu;
i) Starting the food flavoring, cooking, and rapid cooling process, where the chamber pressure is controlled based on a pre-determined pressure setpoint trajectory during food flavoring and rapid cooling, and the chamber temperature is controlled based on a pre-determined temperature setpoint trajectory during cooking;
j) Waiting for a predetermined wait time for the entire food flavoring, cooking, and rapid cooling process;
k) Returning the food chamber pressure to atmosphere pressure; and
l) Removing the food pans from the food chamber.

19. The method of claim 18, wherein the pressure setpoint trajectory is generated in the following form for flavoring and for cooling common types of food:
$$\begin{matrix}Ps ( t ) = Pi ( 0 ) - a * t ; & During initial ramp down period ; \\ Ps ( t ) = C ; & During the first holding period ;\end{matrix}$$
or an equivalent thereof, in which Pi(0)>0 is the initial chamber pressure, and a>0, C>0 are pre-determined constants being used in cooling recipes.

20. The method of claim 18, wherein the pressure setpoint trajectory is generated in the following form so the food chamber pressure is controlled to avoid liquid splash events for food flavoring and for cooling liquid types of food with low viscosity:
$$\begin{matrix}Ps ( t ) = Pi ( 0 ) - a * t ; & During initial ramp down period ; \\ Ps ( t ) = C 1 ; & During the first holding period ; \\ Ps ( t ) = C 1 + b * t ; & During the ramp up period ; \\ Ps ( t ) = C 2 ; & During the second holding period ; \\ Ps ( t ) = C 2 - d * t ; & During the second ramp down period ; \\ Ps ( t ) = C 3 , & During the endpoint period ;\end{matrix}$$
or an equivalent thereof, wherein Pi(0)>0 is the initial chamber pressure, and a>0, b>0, d>0, C1>0, C2>0, C3>0 are pre-determined constants being used in cooling recipes.
